(19) United States
(12) Patent Application Publication
(10) Pub. No.: US 2026/0126402 A1
(43) Pub. Date: May 7, 2026

(54) Methods and Systems for Accurate Temporal Correlation of Non-Stationary X-Ray Beams with Detector Arrays for Enhanced Detection Capabilities

(71) Applicant: Rapiscan Holdings, Inc., Torrance, CA (US)

(72) Inventor: Neil Duncan Carrington, Manchester (GB)

(21) Appl. No.: 19/357,787

(22) Filed: Oct. 14, 2025

Related U.S. Application Data
(60) Provisional application No. 63/714,995, filed on Nov. 1, 2024.

(51) Int. Cl. G01N 23/04; G01N 23/083

(52) U.S. Cl. CPC G01N 23/04; G01N 23/083; G01N 2223/303; G01N 2223/316; G01N 2223/335; G01N 2223/501

(57) ABSTRACT

An X-ray inspection system for inspecting an object includes at least a rotating collimated X-ray source for emitting an X-ray beam, segmented detectors, and a controller. The controller is configured to turn on and off each detector based, at least in part, on a predefined time relative to when the X-ray beam emitted from the X-ray source begins to sweep over the inspection space.

### CROSS-REFERENCE

The present specification relies on U.S. Provisional Patent Application No. 63/714,995 titled “Methods and Systems for Accurate Temporal Correlation of Non-Stationary X-Ray Beams with Detector Arrays for Enhanced Detection Capabilities”, filed on Nov. 1, 2024, for priority. The above-mentioned application is herein incorporated by reference in its entirety.

### FIELD

The present specification relates to X-ray inspection systems that include optimized detection systems with reduced signal to noise ratios. In particular, the present specification relates to the temporal correlation of non-stationary X-ray beams with detector arrays in an X-ray inspection system, such that individual detectors are selectively activated, thereby reducing noise.

### BACKGROUND

Conventionally in X-ray inspection systems comprising an X-ray source and X-ray detectors, all of the detectors are turned on while an X-ray beam emanating from the source sweeps an inspection space lying between the source and the detectors. While a detector is turned on for detecting X-ray beams, the detector also captures noise signals, which eventually have to be filtered out in order to obtain a clean, accurate, and useable X-ray image. Hence, the unwanted noise signals captured by the detectors, occurring even when the detectors are not in the path of a transmitted or scattered X-ray beam, decrease the signal to noise ratio (SNR) of the X-ray inspection system.

There is need for X-ray inspection systems and methods that reduce the capture of unwanted noise by detectors in the course of an X-ray scan. Further, there is a need for an approach that can effectively adapt to any detector geometry and is not limited to a specific detector configuration. Finally, there is a need for an approach that can be reliably implemented in a variety of different scanning systems.

Some examples of different scanning systems include portal, cargo, hand-held and mobile systems. For example, in some embodiments, a portal X-ray scanner may be deployed for scanning people, parcels and pallets. In some embodiments, the X-ray scanner may be configured as a high-energy or dual-energy system for imaging cargo (including containers, vehicles and railcars). Yet again, in some embodiments, the X-ray scanner may be deployed on a mobile inspection vehicle. Exemplary systems include those described in, but not limited to, the following patents and patent publications, which are assigned to the Applicant herein and incorporated by reference: U.S. Pat. Nos. 8,457,275; 8,908,831; 9,562,866; 10,156,642; 10,578,752; 8,633,823; 9,772,426; 10,302,807; 10,768,338; 11,287,391; 9,632,206; 10,386,504; 10,600,609; 9,465,135; 8,579,506; 9,688,517; 8,389,942; 8,993,970; 8,971,485; 9,817,151; 10,754,058; 11,579,328; 9,158,027; 10,585,207; 9,223,052; 11,275,194; 11,768,313; 8,644,453; 9,429,530; 8,433,036; 8,774,357; 9,121,958; 10,007,021; 10,816,691; 9,274,065; 10,698,128; 11,119,245; 11,561,321; 11,852,775; 9,057,679; 9,823,201; 9,835,756; 8,903,046; 9,632,205; 10,408,967; 10,942,291; 11,307,325; 11,822,041; 8,582,720; 9,128,198; 8,389,941; 8,963,094; 9,329,285; 9,218,933; 9,791,590; 10,317,566; 11,550,077; 9,625,606; 9,310,323; 9,557,427.

### SUMMARY

The following embodiments and aspects thereof are described and illustrated in conjunction with systems, tools and methods, which are meant to be exemplary and illustrative, and not limiting in scope. The present application discloses numerous embodiments.

In some embodiments, the present specification is directed towards an X-ray inspection system for inspecting an object placed within an inspection space, the system comprising: at least one rotating collimated X-ray source for emitting an X-ray beam; a plurality of segmented detectors, and a controller, wherein the controller is configured to turn on and off each detector based, at least in part, on a predefined time relative to when the X-ray beam emitted from the X-ray source begins to sweep over the inspection space.

Optionally, the system further comprises a position encoder for recording positions of the rotating collimator X-ray source.

Optionally, the controller is coupled to each of the plurality of segmented detectors, wherein the controller receives the recorded positions of the rotating collimator X-ray source from the position encoder and wherein the controller is configured to turn on and off each of the plurality of segmented detectors based, at least in part, on the received recorded positions.

Optionally, the controller is configured to communicate an initial signal to each plurality of segmented detectors and wherein the initial signal indicates a time when the X-ray beam emitted from the X-ray source begins to sweep the inspection space.

Optionally, each of the plurality of segmented detectors is configured to determine when radiation from the X-ray beam is detected within an integration window.

Optionally, each of the plurality of segmented detectors is configured to communicate to the controller a detection time, relative to the initial signal, in which radiation from the X-ray beam is detected within the integration window.

Optionally, each of the plurality of segmented detectors is configured to transmit its detection time to the controller, wherein the detection time is different for each of the plurality of segmented detectors.

Optionally, the controller is configured to activate each of the plurality of segmented detectors based on its detector-specific detection time.

Optionally, each of the plurality of segmented detectors is calibrated before the object is placed in the inspection space.

Optionally, during calibration, each of the plurality of segmented detectors is turned on concurrently and is configured to record the initial signal and a time of initiation and termination of a peak X-ray signal received by the detector.

Optionally, during calibration, each of the plurality of segmented detectors is configured to determine an acquisition window which is a function of the initial signal, the time of initiation of the received X-ray signal, and the time of termination of the received X-ray signal.

Optionally, during calibration, each of the plurality of segmented detectors is configured to transmit its individual acquisition window to the controller.

Optionally, during a scan of the object, the controller is configured to turn on and off each of the plurality of segmented detectors based on each of the plurality of segmented detectors' transmitted acquisition windows.

In some embodiments, the present specification is directed towards a method of inspecting an object placed within an inspection space, the method comprising: performing a calibration process before inspecting said object, wherein the calibration process comprises: activating at least one rotating collimated X-ray source in order to sweep an X-ray beam across the inspection space from a starting position to an end position; activating each of the plurality of segmented detectors, such that each of the plurality of segmented detectors is turned on concurrently and capable of recording data throughout the X-ray beam's sweep across the inspection space from the starting position to the end position; at each of the plurality of segmented detectors, recording data indicative of a peak X-ray signal and an associated initiation time and an associated termination time of the peak X-ray signal; and using a controller, acquiring said data from each of the plurality of segmented detectors, determining the peak X-ray signal, the associated initiation time and the associated termination time for each of the plurality of segmented detectors, and storing the associated initiation time and the associated termination time for each of the plurality of segmented detectors, inspecting the object by: activating the at least one rotating collimated X-ray source in order to sweep the X-ray beam across the inspection space from the starting position to the end position; activating each of the plurality of segmented detectors, such that each of the plurality of segmented detectors is turned on only at its associated initiation time and turned off only at its associated termination time.

Optionally, during the calibration process, the activation of each of the plurality of segmented detectors is concurrently, and wherein, during said inspecting of the object, the activation of each of the plurality of segmented detectors is sequential.

Optionally, the method further comprises recording positions of the at least one rotating collimator X-ray source using a position encoder.

Optionally, the method further comprises receiving, at the controller, the recorded positions of the at least one rotating collimator X-ray source from the position encoder, wherein the controller is configured to turn on and off each of the plurality of segmented detectors based, at least in part, on the received recorded positions.

Optionally, the controller is configured to communicate an initial signal to each plurality of segmented detectors and wherein the initial signal indicates a time when the X-ray beam begins to sweep the inspection space.

Optionally, each of the plurality of segmented detectors is configured to communicate to the controller a detection time, relative to the initial signal, in which radiation from the X-ray beam is detected.

Optionally, each of the plurality of segmented detectors is configured to transmit its initiation time and termination time to the controller, and wherein the initiation time and termination time is different for each of the plurality of segmented detectors.

Optionally, during the calibration process, each of the plurality of segmented detectors is configured to analyze said data, identify the peak X-ray signal, determine the associated initiation time and the associated termination time of the identified peak X-ray signal, and transmit the associated initiation time and the associated termination time of the identified peak X-ray signal to the controller.

Optionally, during the calibration process, each of the plurality of segmented detectors is configured to transmit said data to the controller and wherein the controller is configured to identify the peak X-ray signal, determine the associated initiation time and the associated termination time of the identified peak X-ray signal, and store the associated initiation time and the associated termination time of the identified peak X-ray signal.

In some embodiments, the present specification is directed towards a non-transient computer readable medium adapted to store programmatic instructions that, when executed, cause an inspection system to be calibrated and cause an object to be inspected within the inspection system by: performing a calibration process before inspecting said object, wherein the calibration process comprises: activating at least one rotating collimated X-ray source in order to sweep an X-ray beam across the inspection space from a starting position to an end position; activating each of the plurality of segmented detectors, such that each of the plurality of segmented detectors is turned on concurrently and capable of recording data throughout the X-ray beam's sweep across the inspection space from the starting position to the end position; at each of the plurality of segmented detectors, recording data indicative of a peak X-ray signal and an associated initiation time and an associated termination time of the peak X-ray signal; and using a controller, acquiring said data from each of the plurality of segmented detectors, determining the peak X-ray signal, the associated initiation time and the associated termination time for each of the plurality of segmented detectors, and storing the associated initiation time and the associated termination time for each of the plurality of segmented detectors; and inspecting the object by: activating the at least one rotating collimated X-ray source in order to sweep the X-ray beam across the inspection space from the starting position to the end position; and activating each of the plurality of segmented detectors, such that each of the plurality of segmented detectors is turned on at its associated initiation time and turned off at its associated termination time.

Optionally, the non-transient computer readable medium further comprises programmatic instructions that, when executed, cause positions of the at least one rotating collimator X-ray source to be recorded using a position encoder.

Optionally, the non-transient computer readable medium further comprises programmatic instructions that, when executed, cause the controller to receive the recorded positions of the at least one rotating collimator X-ray source from the position encoder and to turn on and off each of the plurality of segmented detectors based, at least in part, on the received recorded positions.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skill in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A is an illustration showing an object comprising different materials that is being imaged by an X-ray inspection system, in accordance with an embodiment of the present specification;

FIG. 1B is a graphical representation of image contrast in the resultant X-ray image of the object shown in FIG. 1A;

FIG. 1C shows the graph of FIG. 1B with added noise signals;

FIG. 2 illustrates an inspection system with segmented detectors, in accordance with an embodiment of the present specification;

FIG. 3 is a flow chart illustrating a method of calibrating the X-ray inspection system of FIG. 2, in accordance with an embodiment of the present specification; and

FIG. 4 is a pictorial representation of the X-ray inspection system of FIG. 2 with a graphical representation of integration windows used by the detectors to determine individual acquisition windows, in accordance with an embodiment of the present specification.

### DETAILED DESCRIPTION

The present specification provides X-ray inspection systems and methods for controlling the activation and deactivation, and therefore the detection time, of individual X-ray detectors in an inspection system. Exemplary inspection systems of the present specification comprise a plurality of segmented detectors wherein each detector is turned on at a specific predefined time only when an X-ray beam sweeps over said detector. The method of the present specification enables the inspection system to precisely turn on a detector at an instance of time when an X-ray beam from an X-ray source of the inspection system begins to sweep over the detector. Since the detectors of the present inspection system are not turned on (detecting) at all times, the acquisition of scatter (noise) signals by the detectors is reduced. The inspection system and method of the present specification provide clean detected signals with a high signal to noise ratio.

It is desirable that a detector is turned on only while an X-ray beam is sweeping over the detector, so that the detector captures only the X-ray signal and no noise signals. In theory, one could achieve this objective by employing a basic time calculation, wherein the total time for an X-ray beam to sweep over an inspection space is divided by the number of detectors in the inspection system, and each detector is turned on for an equal, fixed acquisition window starting at a particular time after the X-ray beam begins to sweep the inspection space. However, such a method is subject to substantial errors such as mechanical jitter and latency in the inspection system, which causes the X-ray beam to not sweep the inspection space at a perfectly consistent speed. Additionally, in cases where the inspection space has a non-curved or spherical geometry, such as but not limited to a rectangular inspection space, a basic time calculation where each detector is allotted the same acquisition window is prone to error. Geometrical calculations would be required to be performed in order to account for the greater distance the X-ray beam has to travel to the corners of the inspection space compared to the closer sides of the inspection space. Therefore, a fixed time calculation for controlling on/off times of the detectors may lead to substantial errors as the X-ray beam passes across the inspection space at differing distances to the detector(s). In contrast, embodiments the present invention accurately and precisely only turns on an individual detector when an X-ray beam is ready to sweep over that particular detector. Further, embodiments of the present invention provide for a geometry-independent approach to controlling the on/off time of each of the detectors in the system, thereby reducing scatter contribution and resulting in reduction of noise detected by the system.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It should also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

Noise in X-ray images having the potential to degrade image quality comprise one or more of: scatter noise (υ_{c}) caused by x radiation scattered by the object being scanned; shot noise or Poisson noise (υₚ) which originates from the discrete nature of electric charge in the X-ray inspection system and can be modeled by a Poisson process; and/or electrical noise (υₑ) which is a collection of spontaneous fluctuations in currents and voltages arising from thermal motion of the electrons and from the quantized nature of electric charge in the X-ray inspection system. Hence, the total noise in the X-ray inspection system may be represented as:

$${υ}_{ton} = \sqrt{{υ}_{c}^{2} + {υ}_{p}^{2} + {υ}_{e}^{2}}$$

Image contrast may be defined as the ability to distinguish features of the object being scanned in an image due to the differing X-ray attenuating properties of the object features resulting in visual differences in contrast.

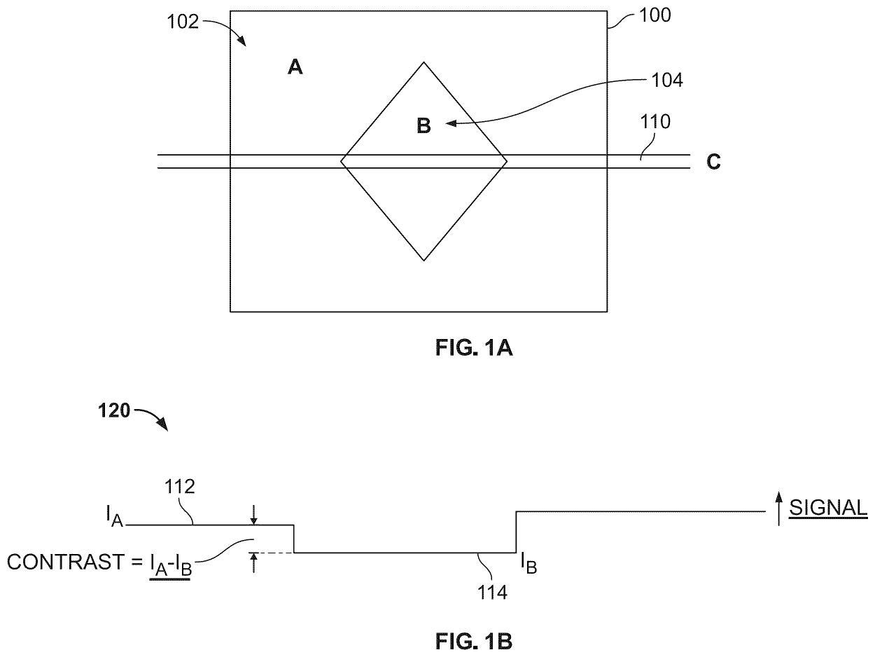

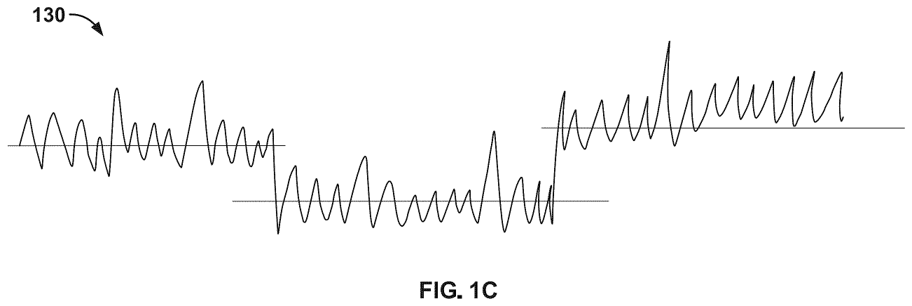

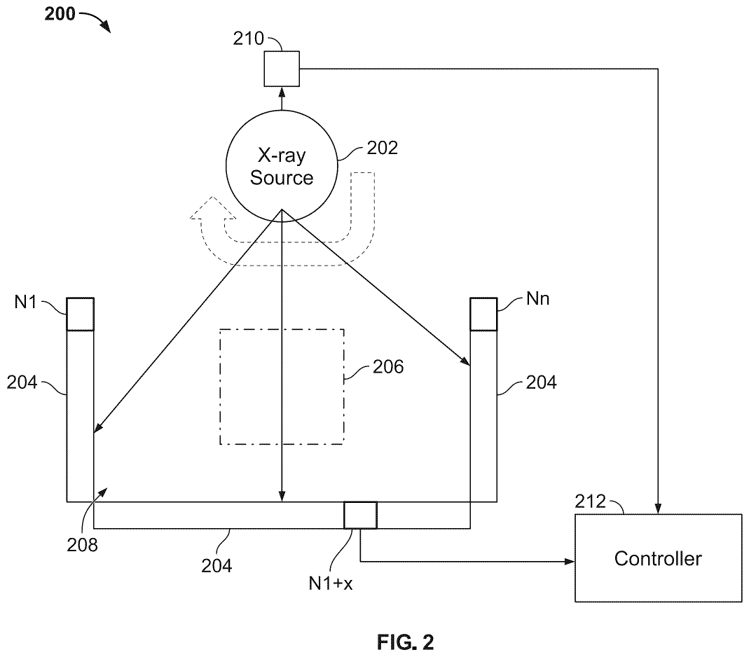

FIG. 1A illustrates an object comprising different materials being imaged by an X-ray inspection system, in accordance with an embodiment of the present specification. Object 100 comprises portions A 102 and B 104 made of different materials such that the X-rays impinging upon object 100 and being detected thereafter, result in a difference in measured signal intensities between portions A 102 and B 104. This difference in signal intensities provides the image contrast. FIG. 1B illustrates a graphical representation of the image contrast in a resultant X-ray image of the object 100 shown in FIG. 1A. Referring to FIGS. 1A and 1B, measured signal intensities with respect to object 100 across a cross sectional axis C 110, is illustrated in graph 120. Portion 112 of graph 110 corresponds to the measured signal intensity across portion A 102; while portion 114 of graph 110 corresponds to the measured signal intensity across portion B 104. The difference in the measured signal intensities 112, 114 provides the image contrast. FIG. 1C illustrates the graph of FIG. 1B with added noise signals. The graph 130 illustrated in FIG. 1C provides a contrast to noise ratio (CNR). In order for an object to be imaged clearly the CNR is typically required to be greater than or equal to 3.

In X-ray inspection systems, the electrical noise (υₑ) and the Poisson noise (υₚ) are more or less fixed by the inspection system hardware and the physics of X-ray generation, respectively. In embodiments of the present specification, scatter noise in X-ray inspection systems is reduced in order to enhance clarity of the corresponding X-ray images. By reducing scatter noise (υ_{c}), the total noise (υₜₒₙ) may be reduced, thereby improving the CNR.

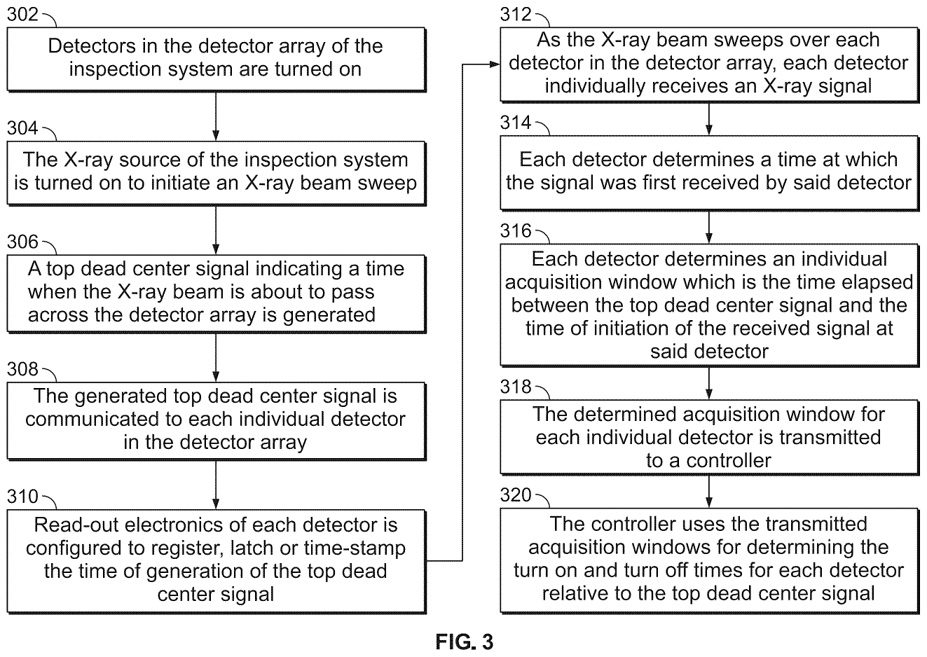

FIG. 2 illustrates an inspection system with segmented detectors, in accordance with an embodiment of the present specification. The system 200 comprises a rotating collimator X-ray source 202, an array 204 of segmented detectors comprising individual detectors N1, N2, Nₓ, . . . Nₙ and an object 206 to be inspected placed in an inspection space 208 between the source 202 and the array 204 of detectors. In embodiments, the source 202 is a rotating collimated source. The system 200 further comprises a position encoder 210 which is configured to capture and record positions of the rotating collimated source 202. The captured positions are transmitted as feedback signals to a controller module 212 which is coupled to each detector N1, N2, Nₓ, . . . Nₙ of the detector array 204 and is configured to control an on time and an off time of each detector. In embodiments, the controller module 212 tracks a time of the beginning/start of an X-ray scan and transmits said time to the detectors N1, N2, Nₓ, . . . Nₙ.

In embodiments, the segmented detector array 204 comprises a plurality of independently operating (distributed) detectors N1, N2, Nₓ, . . . Nₙ. Each of the plurality of detectors is configured such that it is able to determine its own integration windows, essential for identifying the precise time at which an X-ray signal is received by said detector. Additionally, each detector N1, N2, Nₓ, . . . Nₙ is configured such that it is able to receive and recognize a ‘top dead center signal’, indicating a time when the source X-ray beam begins to sweep the inspection space 208. In embodiments, a predefined angular reference position of the rotating collimator X-ray source 202 is defined as a top dead center position. The top dead center position is mechanically fixed and remains unchanged during the entire scanning operation. The top dead center signal is used by each detector N1, N2, Nₓ, . . . Nₙ to determine a time when the rotating X-ray beam is incident on the detector in order for the detector to begin signal accumulation/integration.

In embodiments, a Hall effect sensor, which is sensitive to changes in magnetic field, is used as a top dead center detector. In an embodiment, a magnet is coupled with a periphery of a rotating wheel of the collimated X-ray source 202, in order to trigger the Hall effect sensor during rotation of the source.

In embodiments each of the detectors, of the detector array 204, comprises a beam sensor such as, but not limited to, a photodiode. In embodiments, the detector array 204 comprises N independent, individual detectors. While N is typically on the order of 80, N could be any value depending upon the size of the detector and the geometry of the complete array. In an embodiment, each detector N1, N2, Nₓ, . . . Nₙ comprises a block of scintillating crystal material with at least a first face optically coupled to a photo-diode. When incident X-rays fall on a detector face not coupled with the photodiode, the X-rays cause the scintillator material to generate light (glow), which is then conveyed to the photodiode via total internal reflection of the light within the block of scintillating crystal material. The photodiode converts the light into electrical current which is proportional to the amount of light generated. The electric current is converted into measurable digital values by the detector electronics. In embodiments, a ‘photo-multiplier-tube (PMT)’ or a ‘Silicon-photo-multiplier (SIPM) may be used instead of photodiodes.

In embodiments, the on and off timing of each detector N1, N2, Nₓ, . . . Nₙ is calibrated before any actual inspection is performed, in other words, when there is no object 206 requiring inspection present in the inspection space 208 and thus space 208 is empty. The calibration may be performed once at the time of manufacture of the inspection system 200 and at multiple predefined times such as, but not limited to: every time the inspection system 200 is started, every time a speed of the rotating collimator source 202 is changed, after each object 206 is scanned, predefined fixed times within a predetermined time period, such as a day, and when standard detector calibration checks are performed.

In embodiments, during a calibration phase, all the detectors N1, N2, Nₓ, . . . Nₙ in the detector array 204 are turned on concurrently. The source 202 is turned on to initiate an X-ray beam sweep (from a predetermined starting position to a predetermined end position) and the top dead center signal indicating a time when the X-ray beam is about to pass across the detector array 204 is generated. In some embodiments, the top dead center signal is generated by using either a Hall effect sensor or via an optical light shining through a hole.

The generated top dead center signal is communicated to each individual detector N1, N2, Nₓ, . . . Nₙ. In embodiments, the controller module 212 receives the top dead center signal and communicates the top dead center signal to each individual detector. In an embodiment, the controller module 212 communicates directly via either electrical, optical, or radio means with each detector.

In embodiments, each detector N1, N2, Nₓ, . . . Nₙ temporarily stores a digital representation of the timing of the communicated top dead center signal. Stated differently, read-out electronics of each detector N1, N2, Nx, . . . Nn is interfaced with the communicated top dead center signal and is configured to register, latch or time-stamp the time of generation of the top dead center signal. As the X-ray beam sweeps over the detector array 204, each detector N1, N2, Nₓ, . . . Nₙ individually is configured to determine a time of initiation and a time of termination of a peak X-ray signal received and an acquisition window, where the acquisition window is the time elapsed between the generation of the top dead center signal and the time of initiation of the received signal. In embodiments, each detector N1, N2, Nₓ, . . . Nₙ comprises additional circuit capacity allowing the detectors to interface with the top dead center signal, in order to determine the acquisition window.

In one embodiment, each detector N1, N2, Nₓ, . . . Nₙ comprises on-board circuitry or processing logic configured to locally analyze the received X-ray signal to identify a peak X-ray signal and determine corresponding initiation and termination times. In such embodiments, each detector itself calculates its own peak X-ray signal initiation and termination times by referencing the latched top dead center timing and internally processing the detected signal waveform. In another embodiment, each detector N1, N2, Nx, . . . Nn is configured primarily as a data acquisition unit that records the raw signal intensity as a function of time relative to the communicated top dead center signal and transmits this raw data to the controller module 212. The controller module 212 is, in turn, configured to process the received signal data from each detector to determine the initiation and termination of the peak X-ray signal on a detector-by-detector basis. Thus, the system accommodates both detector-level and controller-level determination of timing parameters associated with the received X-ray signals.

The determined acquisition window for each detector N1, N2, Nₓ, . . . Nₙ is communicated to the controller module 212 and represents the times when each individual detector is required to be turned on and off during an inspection operation. In an embodiment a central processor (not shown in FIG. 2) is coupled with the detectors N1, N2, Nₓ, . . . Nₙ for determining the acquisition windows for each of said detectors.

During operation, each detector N1, N2, Nₓ, . . . Nₙ is turned on and off based on the acquisition windows for each of said detectors obtained during the calibration phase.

In embodiments, the turn on and turn off times determined by using the above system and method is geometry independent, as each detector N1, N2, Nₓ, . . . Nₙ obtains an individual acquisition window and is therefore not dependent on any geometric calculations. Hence, the above described inspection system and method is a low cost embodiment that reduces scatter contribution and achieves a reduction in noise.

FIG. 3 is a flow chart illustrating a method of calibrating the X-ray inspection system of FIG. 2, in accordance with an embodiment of the present specification. In embodiments, the detectors of the inspection system are calibrated before any actual inspection is performed, meaning when no object requiring inspection present in the inspection space and said space is empty.

At step 302, all the detectors in the detector array of the inspection system are turned on. At step 304, the X-ray source of the inspection system is turned on to initiate an X-ray beam sweep. At step 306, a top dead center signal indicating a time when the X-ray beam is about to pass across the detector array is generated. At step 308, the generated top dead center signal is communicated to each individual detector in the detector array. At step 310, the read-out electronics of each detector is configured to register, latch or time-stamp the time of generation of the top dead center signal. At step 312, as the X-ray beam sweeps over each detector in the detector array, each detector individually receives an X-ray signal. At step 314, each detector determines a time at which the signal was first received by said detector. In an embodiment, each detector determines a time at which the signal was first received by said detector by passing an integration window over the acquired signal data. In an embodiment, each detector determines when a peak X-ray signal first initiated and then terminated for said detector.

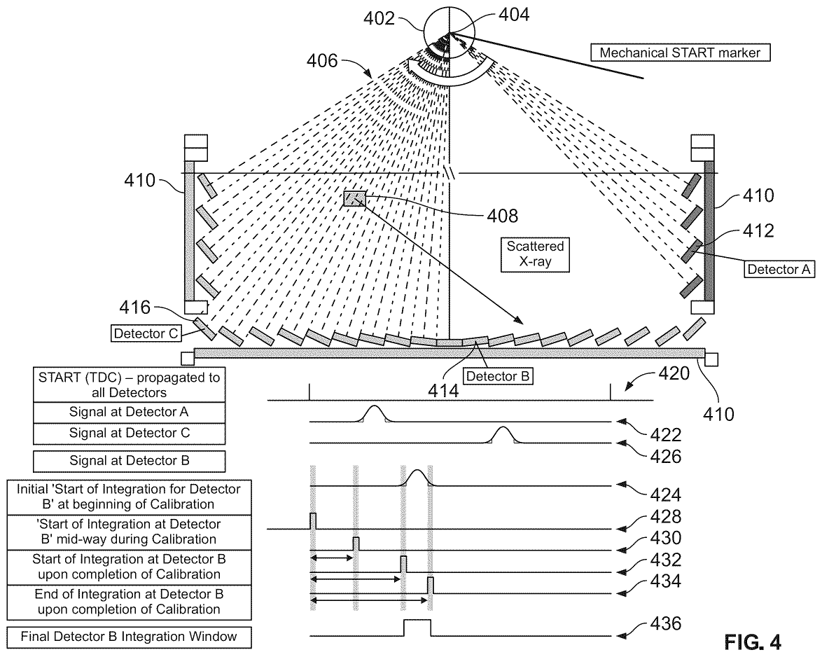

FIG. 4 illustrates a pictorial representation of the X-ray inspection system of FIG. 2 along with a graphical representation of integration windows used by the detectors to individually determine acquisition windows, in accordance with an embodiment of the present specification. As can be seen in FIG. 4, an X-ray source 402 comprising a mechanical start marker 404 emits X-ray beam 406 which after impinging upon an object 408 requiring inspection is detected by an array 410 of segmented detectors, such as detector ‘A’ 412, detector ‘B’ 414 and detector ‘C’ 416 in FIG. 4. In embodiments, the mechanical start marker 404 acts as a marker/pointer/trigger for the top-dead-center signal. The X-rays scattered by the object 408 are also collected by the detector array 410, which comprised the individual detectors.

Graph 420 represents a start of top-dead-center converter (TDC) which is used to convert time intervals into digital values, critical for synchronizing the detected signals with the rotation of the X-ray source 402, and is propagated to all of the detectors in the detector array 410. Graph 422 represents a signal received at detector ‘A’ 412, graph 424 represents a signal received at detector ‘B’ 414 and Graph 426 represents a signal received at detector ‘C’ 416.

Graph 428 represents an initial start of integration for detector ‘B’ 414 at a beginning of calibration of the inspection system. At the beginning of calibration, it is not known exactly when detector ‘B’ 414 will receive the X-ray beam relative to the top dead center signal. Thus, an initial estimate for the start of integration is used. Graph 430 represents a start of integration for detector ‘B’ 414 at mid-way during calibration of the inspection system. As a result, mid-way during calibration the inspection system adjusts the integration start time based on the measured signal onset. The start point shifts closer to the actual rising edge of the received X-ray signal at detector ‘B’ 414. Graph 432 represents a start of integration for detector ‘B’ 414 upon completion of calibration of the inspection system. In other words, after calibration converges, the inspection system learns the exact phase delay between the top dead center signal and the X-ray signal onset (for example, based on a signal rise above a predetermined threshold) at detector ‘B’ 414. The integration start is now properly aligned. Graph 434 represents an end of integration for detector ‘B’ 414 upon completion of calibration of the inspection system. That is, the inspection system determines when the X-ray signal terminates (for example, based on a signal fall below threshold) at detector ‘B’ 414. This marks the proper end of integration. Graph 436 represents a final integration window for detector ‘B’ 414.

Referring back to FIG. 3, at step 316, each detector determines an individual acquisition window which is the time elapsed between the top dead center signal and the time of initiation of the received signal at the detector. At step 318, the determined acquisition window for each individual detector is communicated to or transmitted to a controller. At step 320, the controller (which is configured to do so) uses the transferred acquisition windows for determining the turn on and turn off times for each detector relative to the top dead center signal. In embodiments, during an operation phase of the inspection system the controller (which is configured to do so) turns on and turns off each detector by using the determined turn on and turn off times.

Thus, an acquisition window is defined as the interval during which raw X-ray data are collected in synchrony with the motion of the rotating X-ray source. During calibration, the acquisition window begins at the generation of the top-dead-center signal and remains open until the X-ray beam has swept across the entire inspection space, thereby ensuring continuous collection of data from all detectors regardless of their individual timing offsets.

In contrast, an integration window is applied within the acquisition window to the raw data of each detector in order to identify the precise interval over which that detector receives the X-ray beam. The integration window is used to determine the initiation and termination of a valid signal for each detector, and the resulting detector-specific on-time and off-time are stored by the controller. During operation, these stored timings are employed by the controller to define detector-specific acquisition windows, such that each detector is activated only during its calibrated interval of valid X-ray exposure.

In some embodiments, the top dead center signal as well as the time determined by each detector individually at which an X-ray signal was first received by said detector by passing an integration window over the acquired signal data for obtaining when a peak X-ray signal first initiated and then terminated for said detector is sent to a central processor. The central processor then uses the received data from the detectors and determine the acquisition window for each detector.

In embodiments, a controller of the inspection system with segmented detectors is configured to activates/deactivate a specific detector based on a time calculation. In embodiments, the time calculation includes determining a top dead center signal and/or a position calculation, wherein the position calculation comprises determining a position of the X-ray beam as it is passing over the specific detector.

In embodiments, the activation/deactivation method of a detector located within the inspection system is influenced by a determination of the speed of the rotating X-ray beam that is required to change dynamically. In embodiments which use the top dead center signal for activating/deactivating the detectors, the top dead center signal is required to be received by each detector and a re-calibration of the timing is required only if the speed of the rotating X-ray beam changes.

In embodiments using the position calculation for activating/deactivating the detectors, the position information of the X-ray beam as it is passing over the detectors is required to be continuously sent to each detector, however, re-calibration is not required if the speed of the rotating X-ray beam changes.

In various embodiments, during operation, each detector is turned on and off based on the acquisition window for each detector acquired during the calibration phase. Hence, the system of the present specification provides a geometry independent approach for controlling the on/off time of each of the detectors in the system, which is not dependent on geometric calculations, thereby reducing scatter contribution and resulting in reduction of noise in the system.

The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. An X-ray inspection system for inspecting an object placed within an inspection space, the system comprising:
at least one rotating collimated X-ray source for emitting an X-ray beam;
a plurality of segmented detectors, and
a controller, wherein the controller is configured to turn on and off each detector based, at least in part, on a predefined time relative to when the X-ray beam emitted from the X-ray source begins to sweep over the inspection space.

2. The system of claim 1, further comprising a position encoder for recording positions of the rotating collimator X-ray source.

3. The system of claim 2, wherein the controller is coupled to each of the plurality of segmented detectors, wherein the controller receives the recorded positions of the rotating collimator X-ray source from the position encoder and wherein the controller is configured to turn on and off each of the plurality of segmented detectors based, at least in part, on the received recorded positions.

4. The system of claim 1, wherein the controller is configured to communicate an initial signal to each plurality of segmented detectors and wherein the initial signal indicates a time when the X-ray beam emitted from the X-ray source begins to sweep the inspection space.

5. The system of claim 4, wherein each of the plurality of segmented detectors is configured to determine when radiation from the X-ray beam is detected within an integration window.

6. The system of claim 5, wherein each of the plurality of segmented detectors is configured to communicate to the controller a detection time, relative to the initial signal, in which radiation from the X-ray beam is detected within the integration window.

7. The system of claim 6, wherein each of the plurality of segmented detectors is configured to transmit its detection time to the controller, and wherein the detection time is different for each of the plurality of segmented detectors.

8. The system of claim 7, wherein the controller is configured to activate each of the plurality of segmented detectors based on its detector-specific detection time.

9. A method of inspecting an object placed within an inspection space, the method comprising:
performing a calibration process before inspecting said object, wherein the calibration process comprises:
activating at least one rotating collimated X-ray source in order to sweep an X-ray beam across the inspection space from a starting position to an end position;
activating each of the plurality of segmented detectors, such that each of the plurality of segmented detectors is turned on concurrently and capable of recording data throughout the X-ray beam's sweep across the inspection space from the starting position to the end position;
at each of the plurality of segmented detectors, recording data indicative of a peak X-ray signal and an associated initiation time and an associated termination time of the peak X-ray signal; and
using a controller, acquiring said data from each of the plurality of segmented detectors, determining the peak X-ray signal, the associated initiation time and the associated termination time for each of the plurality of segmented detectors, and storing the associated initiation time and the associated termination time for each of the plurality of segmented detectors,
inspecting the object by:
activating the at least one rotating collimated X-ray source in order to sweep the X-ray beam across the inspection space from the starting position to the end position;
activating each of the plurality of segmented detectors, such that each of the plurality of segmented detectors is turned on only at its associated initiation time and turned off only at its associated termination time.

10. The method of claim 9, wherein, during said calibration process, the activation of each of the plurality of segmented detectors is concurrently, and wherein, during said inspecting of the object, the activation of each of the plurality of segmented detectors is sequential.

11. The method of claim 9, further comprising recording positions of the at least one rotating collimator X-ray source using a position encoder.

12. The method of claim 11, further comprising receiving, at the controller, the recorded positions of the at least one rotating collimator X-ray source from the position encoder, wherein the controller is configured to turn on and off each of the plurality of segmented detectors based, at least in part, on the received recorded positions.

13. The method of claim 9, wherein the controller is configured to communicate an initial signal to each plurality of segmented detectors and wherein the initial signal indicates a time when the X-ray beam begins to sweep the inspection space.

14. The method of claim 13, wherein each of the plurality of segmented detectors is configured to communicate to the controller a detection time, relative to the initial signal, in which radiation from the X-ray beam is detected.

15. The method of claim 9, wherein each of the plurality of segmented detectors is configured to transmit its initiation time and termination time to the controller, and wherein the initiation time and termination time is different for each of the plurality of segmented detectors.

16. The method of claim 9, wherein, during the calibration process, each of the plurality of segmented detectors is configured to analyze said data, identify the peak X-ray signal, determine the associated initiation time and the associated termination time of the identified peak X-ray signal, and transmit the associated initiation time and the associated termination time of the identified peak X-ray signal to the controller.

17. The method of claim 9, wherein, during the calibration process, each of the plurality of segmented detectors is configured to transmit said data to the controller and wherein the controller is configured to identify the peak X-ray signal, determine the associated initiation time and the associated termination time of the identified peak X-ray signal, and store the associated initiation time and the associated termination time of the identified peak X-ray signal.

18. An non-transient computer readable medium adapted to store programmatic instructions that, when executed, cause an inspection system to be calibrated and cause an object to be inspected within the inspection system by:
performing a calibration process before inspecting said object, wherein the calibration process comprises:
activating at least one rotating collimated X-ray source in order to sweep an X-ray beam across the inspection space from a starting position to an end position;
activating each of the plurality of segmented detectors, such that each of the plurality of segmented detectors is turned on concurrently and capable of recording data throughout the X-ray beam's sweep across the inspection space from the starting position to the end position;
at each of the plurality of segmented detectors, recording data indicative of a peak X-ray signal and an associated initiation time and an associated termination time of the peak X-ray signal; and
using a controller, acquiring said data from each of the plurality of segmented detectors, determining the peak X-ray signal, the associated initiation time and the associated termination time for each of the plurality of segmented detectors, and storing the associated initiation time and the associated termination time for each of the plurality of segmented detectors; and
inspecting the object by
activating the at least one rotating collimated X-ray source in order to sweep the X-ray beam across the inspection space from the starting position to the end position; and
activating each of the plurality of segmented detectors, such that each of the plurality of segmented detectors is turned on at its associated initiation time and turned off at its associated termination time.

19. The non-transient computer readable medium of claim 18, further comprising programmatic instructions that, when executed, cause positions of the at least one rotating collimator X-ray source to be recorded using a position encoder.

20. The non-transient computer readable medium of claim 18, further comprising programmatic instructions that, when executed, cause the controller to receive the recorded positions of the at least one rotating collimator X-ray source from the position encoder and to turn on and off each of the plurality of segmented detectors based, at least in part, on the received recorded positions.
